(19) United States
(12) Patent Application Publication
(10) Pub. No.: US 2012/0290925 A1
(43) Pub. Date: Nov. 15, 2012

(54) Incremental Graphic Object Layout Editing

(76) Inventors: Clayton Brian Atkins, Mountain View, CA (US); Niranjan Damera-Venkata, Mountain View, CA (US); Eamonn O'brien-Strain, San Francisco, CA (US); Nina Bhatti, Los Altos, CA (US)

(21) Appl. No.: 13/511,832

(22) PCT Filed: Jan. 29, 2010
(86) PCT No.: PCT/US2010/022551

§ 371 Date: May 24, 2012

(51) Int. Cl. G06F 17/00

(52) U.S. Cl. 715/243

(57) ABSTRACT

A method for incremental graphic object layout editing performed by physical computing system (100) includes associating an initial layout (300) of graphic objects (302) with a data structure; generating a screen map (304) associated with the initial layout (300), the screen map (304) comprising at least one region (306) associated with at least one of the graphic objects (302) from the initial layout (300), the region (306) comprising a number of sub-regions (308, 310) for each graphic object associated with the region (306); providing to a user (112) a cursor (412) allowing the user (112) to indicate a selected region; updating the data structure in response to an editing action based in part on the selected region and a position of the cursor (412) relative to one of the sub-regions (308, 310), the graphic objects not related to the editing action maintaining their relative positions within the data structure; and rearranging the initial layout (300) and the screen map (304) according to the updated data structure.

### BACKGROUND

Individuals and organizations are rapidly accumulating large collections of digital content, including still images, text, graphics, animated graphics, and full-motion video images. This content may be presented individually or combined in a wide variety of different forms, including documents, catalogs, presentations, still photographs, commercial videos, home movies, and metadata describing one or more associated digital content files. As these collections grow in number and diversity, individuals and organizations increasingly will require systems and methods for organizing and presenting the digital content in their collections. To meet this need, a variety of different systems and methods for organizing and presenting digital content have been proposed.

For example, there are several digital albuming systems that enable users to create digital photo albums. Some of these systems provide a means for automatically arranging a layout of graphic objects. Through such systems, the graphic objects may be resized according to certain restrictions. These systems may save a user time and effort in finding an aesthetically acceptable arrangement of graphic objects. In some cases, a user may want to make a few edits to an automatically arranged layout. However, typical systems which provide automatic layouts will rearrange the entire layout in response to an addition, move or removal of a graphic object. Thus, the user may find it difficult to get the layout in a desired state using an automatic graphic object arrangement process.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one embodiment of principles described herein.

FIG. 2A is a diagram showing an illustrative layout of graphic objects on a page, according to one embodiment of principles described herein.

FIG. 2B is a diagram showing an illustrative binary tree used to represent the layout of the graphic objects shown in FIG. 2A, according to one embodiment of principles described herein.

FIG. 3A is a diagram showing an illustrative graphic object layout, according to one embodiment of principles described herein.

FIG. 3B is a diagram showing an illustrative screen map associated with a graphic object layout, according to one embodiment of principles described herein.

FIGS. 4A and 4B are diagrams showing an illustrative user interface before and after an additional graphic object is added to the layout, according to one embodiment of principles described herein.

FIGS. 5A and 5B are diagrams showing an illustrative user interface before and after a graphic object is removed from the layout, according to one embodiment of principles described herein.

FIGS. 6A and 6B are diagrams showing an illustrative user interface before and after two graphic objects are swapped within the layout, according to one embodiment of principles described herein.

FIGS. 7A and 7B are diagrams showing an illustrative user interface before and after one of the graphic objects is repositioned within the layout, according to one embodiment of principles described herein.

FIGS. 8A and 8B are diagrams showing an illustrative user interface before and after one of the graphic objects is repositioned within the layout, according to one embodiment of principles described herein.

FIGS. 9A-9C are diagrams showing illustrative tree structures representing layouts of graphic objects, according to one embodiment of principles described herein.

FIG. 10 is a diagram showing an illustrative user interface displaying statistics related to a graphic object layout, according to one embodiment of principles described herein.

FIG. 11 is a flowchart showing an illustrative method for incremental graphic object editing, according to one embodiment of principles described herein.

Throughout the drawings, identical reference numbers designate similar, but not necessarily identical, elements.

### DETAILED DESCRIPTION

As mentioned above, there are several digital albuming systems that enable users to create digital photo albums. Some of these systems provide a means for automatically arranging a layout of graphic objects. These systems may save a user time and effort in finding an aesthetically acceptable arrangement of graphic objects. However, typical systems which provide automatic layouts will rearrange the entire layout in response to additions and removals of graphic objects. Thus, the user may find it difficult to reach a desired state using an automatic graphic object arrangement function. Ideally, a user should be able to view the layout in its current state and determine a sequence of editing actions which will bring the layout into a desired state.

In light of the above mentioned issues, the present specification relates to a method for incremental graphic object layout editing. According to certain illustrative embodiments, an initial layout of graphic objects may be represented by a binary tree structure. A screen map may then be generated in which regions of the screen map correspond to graphic objects within the initial layout. Each region may then be further divided into sub-regions. Through use of a cursor, a user may select a graphic object to be involved in an editing action. The editing action to be performed may be determined by a position of the cursor related to position of the sub-regions. The binary tree structure representing the graphic object layout may then be updated in response to the performed editing action. The initial layout and corresponding screen map may then be rearranged according to the updated binary tree structure. The rearrangement of the initial layout may maintain the relative positions of the graphic objects not involved with the editing action. However, the graphic objects not involved with the editing actions may be resized according to a graphic object resizing function.

Through use of a system or method embodying principles described herein, a user may intuitively perform editing actions incrementally without having the layout rearranged after each performed edit. Thus, a user may take advantage of systems which automatically rearrange and resize graphic objects and still move the layout towards a desired state.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Throughout this specification and in the appended claims, the term “physical computing system” is to be broadly interpreted as a computing system capable of arranging graphic objects on a page and displaying an arrangement of the graphic objects to a user.

Throughout this specification and in the appended claims, the term “graphic object” is to be broadly interpreted as an image that can be selectively arranged on a page using graphic layout software. A “graphic object” as defined herein may include, but is not limited to, a photographic image, a non-photographic image, and a block of text.

Throughout this specification and in the appended claims, the term “layout” is to be broadly interpreted as an arrangement of graphic objects on a page. The term “page” is to be broadly interpreted as a fixed area upon which a layout may be presented to a user. A page may refer to a physical medium or an electronic medium displayed to a user through a display device.

Throughout this specification and in the appended claims, the term “cursor” is to be broadly interpreted as an object denoting the location on a display in which a user is pointing out through use of an input device. In systems which a display and input device are separate, such as a mouse or a touchpad, a marker may be displayed to a user where the cursor is currently located. In systems which the display and input device are integrated, such as a touch-screen, there may be no need to display a marker indicating where the cursor is.

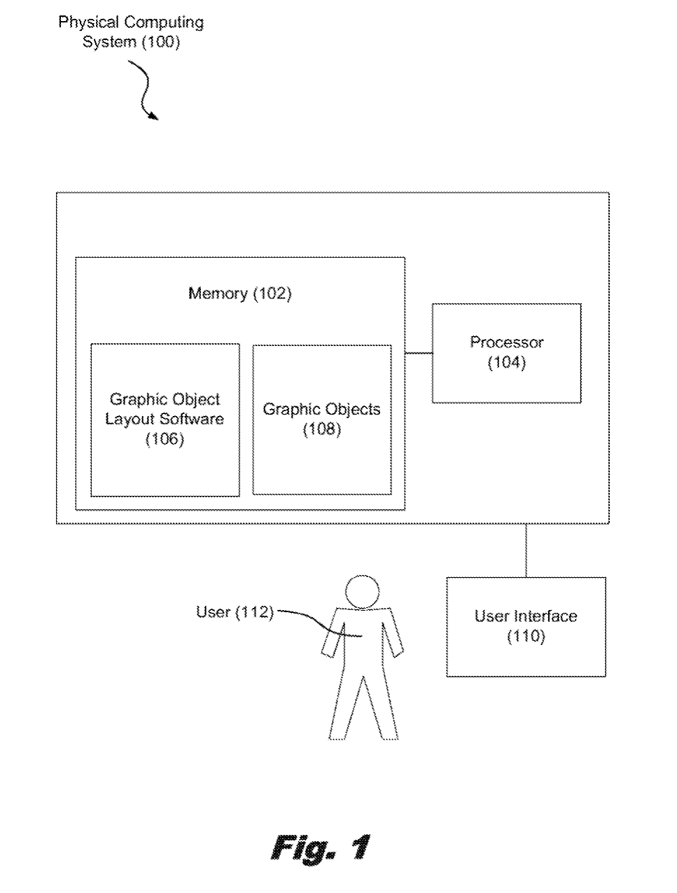

Referring now to the figures, FIG. 1 is a diagram showing an illustrative physical computing system (100). According to one illustrative embodiment, a physical computing system (100) may include a processor (104), a user interface (110), and a memory (102) having graphic object layout software (106) and a number of graphic objects (108) stored thereon.

The physical computing system (100) may be embodied as several different types of computing devices including, but not limited to, a laptop computer, a desktop computer, or a Personal Digital Assistant (PDA). According to a number of frameworks well known in the art, the system may be distributed geographically. For example, the UI may be running on a client computer with the memory and processor running on a server computer. The physical computing system (100) may include a form of memory (102) including, but not limited to, a magnetic disk drive, a solid state drive, and/or an optical disc drive.

The graphic layout software (106) stored by the memory (102) may be embodied as computer readable code configured to cause a processor (104) to execute various instructions related to the creation and editing of a layout of graphic objects (108) on a page.

A graphic object (108) may be any type of image including, but not limited to, a photo, a text block, or a piece of artwork. A collection of graphic objects (108) may include images imported from another memory medium as well as images designed and/or created with the physical computing system (100).

The user interface (110) may enable interaction between the physical computing system (100) and a user (112). The user interface (110) may include a display device as well as an input receiving device such as a keyboard or a mouse. Through the user interface (110), a user (112) is able to send commands to the physical computing system (100). These commands may involve the layout of graphic objects (108). Information about graphic objects (108) and their layout may be presented to the user (112) through the display device.

The graphic layout software (106) may implement a variety of algorithms for processing data regarding the layout of graphic objects (108). The layout of graphic objects on a page may be represented by a binary tree structure.

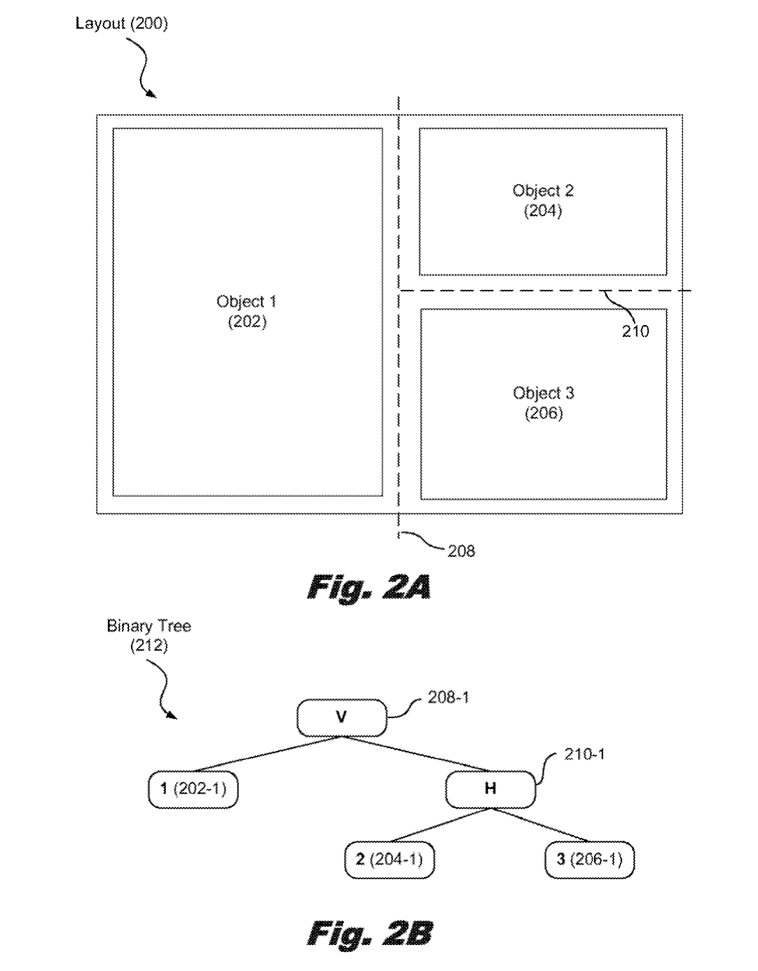

FIG. 2A is a diagram showing an illustrative layout (200) of graphic objects on a page which may be represented as a binary tree. FIG. 2B is a diagram of an illustrative binary tree representing the layout shown in FIG. 2A. According to one illustrative embodiment, a set of graphic objects (202, 204, 206) may be distributed among partitions of a page defined by vertical (208) and horizontal (210) divisions.

A binary tree (212) is a data tree structure having multiple nodes arranged hierarchically such that each node contains either zero or two child nodes. When a binary tree represents a layout of graphic objects, the root node represents the first division of a page. A division may be either horizontal or vertical. In the case of FIG. 2, the first division is a vertical division (208). Thus the root node (208-1) represents the first vertical division (208).

Each child node represents the graphic objects on one side of a division. In one exemplary convention, in the case of a vertical division, the left child node represents the graphic object(s) on the left side of the division and the right child node represents the graphic object(s) on the right side of the division. In the case of FIG. 2, the left child node (202-1) of the root node (208-1) represents Object 1 (202) and the right child node (210-1) of the root node (208-1) represents Object 2 (204) and Object 3 (206).

A child node may represent a further division instead of a graphic object. In the case of FIG. 2, the right child node (210-1) of the root node (208-1) represents a horizontal division. Like a vertical division node, one child node of the division node represents the graphic object(s) on one side of the division and the other child node represents the graphic object(s) on the other side of the division. In the case of FIG. 2, the left child node (204-1) of the horizontal division node (210-1) represents Object 2 which is above the horizontal division (210) and the right child node (206-1) represents Object 3 (206) which is below the horizontal division (210).

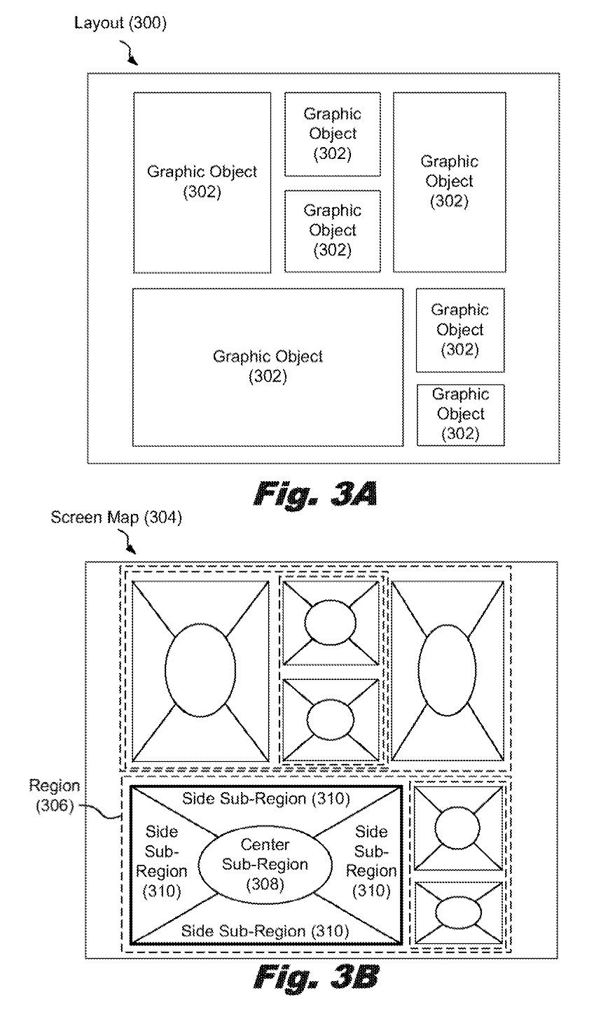

FIG. 3A is a diagram showing an illustrative graphic object layout (300). According to certain illustrative embodiments, a number of graphic objects (302) may be arranged as shown in FIG. 3. The initial arrangement shown may be created manually or automatically.

There are systems available which will take a number of graphic objects (302) and automatically organize them as well as resize them if necessary. During the graphic object sizing process, an automatic graphic object arrangement system may work under a set of constraints. For example, the system may only change the overall area of a graphic object (302) and not change the aspect ratio of the graphic object (302). In some cases a minimal amount of cropping may be allowed by the system. An example of one such graphic object sizing process, in which a height and width are automatically assigned to each graphic object (302) within a layout represented by a binary tree structure can be found in C. B. Atkins, “Blocked recursive image composition”, in Proceedings of the 16^{th} ACM international Conference on Multimedia, Vancouver, British Columbia, Canada, Oct. 26-31, 2008.

FIG. 3B is a diagram showing an illustrative screen map (304) associated with a graphic object layout (300). According to certain illustrative embodiments, a screen map (304) may be generated so that it corresponds with an accompanying graphic object layout (302). Each graphic object within the layout may correspond to a region (306) within the screen map (304). Each region (306) may then be divided into a number of sub-regions (308,310).

In some embodiments, a region (306) may include five sub-regions (308, 310); one center sub-region (308) and four side sub-regions (310). The precise boundaries between the sub-regions may vary depending on the implementation. As shown in FIG. 3B, the center sub-region (308) corresponds to an oval matching the aspect ratio of the region (306). However, any suitable number of sub-regions (308, 310) and sub-region boundary formations may be used.

The screen map (304) may or may not be displayed to a user. In some embodiments, the screen map (304) may be displayed optionally as a transparent overlay. In some cases, the sub-region (308, 310) in which a cursor is currently being held over may be displayed.

In some embodiments, a region may be assigned to each node within the binary tree structure representing a layout, including interior and exterior nodes. In such an embodiment, a number of nested rectangles, shown as dotted lines in FIG. 3B, may be displayed over the layout. The nesting relationships themselves may represent an underlying hierarchical structure such as a binary tree structure. The nested rectangles may be placed so that the perimeter of an inner rectangle is a specific distance from the perimeter of the next outer rectangle. The specific distance may be wide enough to easily allow a user to position a cursor within the gap between the rectangle perimeters.

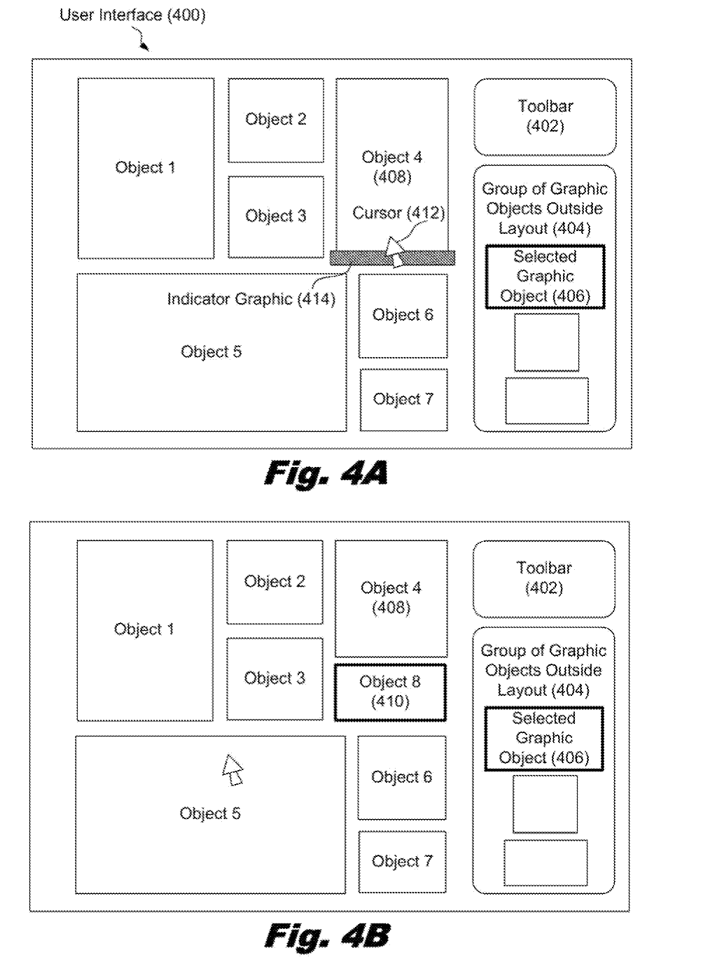

FIG. 4A is a diagram showing an illustrative user interface (400) before an additional graphic object is added to the layout. According to certain illustrative embodiments, one of the editing actions able to be performed by a user may be to add an additional graphic object to the layout. This may be done by selecting a graphic object (406) from a group (404) of graphic objects outside the initial layout. A cursor (412) may then be moved to a location within the layout to determine where within the layout the selected graphic object (406) should be placed.

For example, a user may control the cursor (412) with an input device such as a mouse, touchpad, or touch-screen. With the cursor, the user may select a desired graphic object (406) to be added to the layout by “clicking” on a thumbnail view of the desired graphic object (406). The act of clicking refers to pressing a button on an input device such as a mouse. When using a mouse, the user may then hold down the button and “drag” the selected object to the desired location. The placement of the graphic object within the layout may be determined by the location of the cursor when the user releases the mouse button. For example, if the cursor is located within the lower side region is associated with object 4 (408) when the mouse button is released, then the selected graphic object (406) may be placed adjacent to the bottom border of object 4 (408).

Throughout this specification, actions may be described in terms of using a mouse as an input device. However, use of a mouse is merely one option for an input device. The terms associated with a mouse such as “button,” “click,” or “drag” may have corresponding terms for different input devices. For example, a click with a mouse may correspond to a “tap” on a touch-screen.

In some embodiments, an indicator graphic (414) may be displayed to a user indicating which sub-region the cursor is presently being held over. For example, the border associated with a particular sub-region may light up if the cursor is being held over that particular sub-region. Additionally or alternatively, the indicator graphic may include an animation. The animation may display a wiggling line or a scrolling design.

FIG. 4B is a diagram showing an illustrative graphic object layout after the selected graphic object (406) has been added to the layout. To add the graphic object (410) to the layout, the binary tree structure representing the layout may first be updated. Based on the placement of the additional node within the binary tree structure, the added object (410) has been placed so that its upper border is adjacent to the lower border of object 4 (408). The added object (410) may be scaled so that its width matches the width of object 4 (408). Additionally, all other objects not involved with the addition of a graphic object maintain their relative positions. While maintaining their positions, they may experience resizing as appropriate and as determined by a graphic object resizing function which may be in use.

In some embodiments, the user interface (400) may include a toolbar (402). The toolbar (402) may contain a number of options and functions related to the creating and incrementally editing layouts of graphic objects.

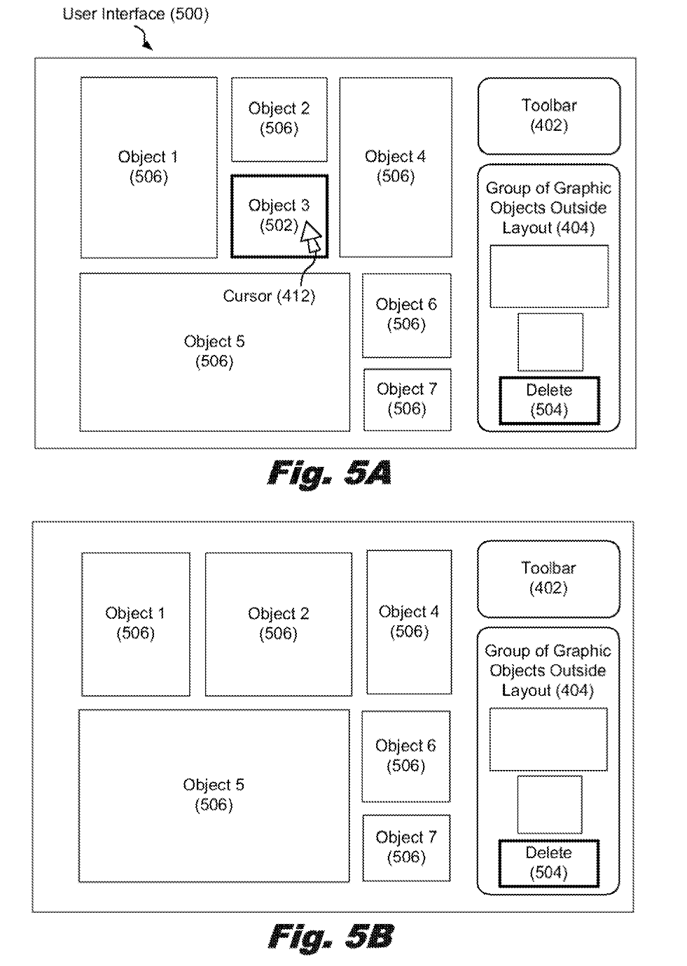

FIG. 5A is a diagram showing an illustrative user interface (500) before a graphic object is removed from the layout. According to certain illustrative embodiments, one of the editing actions able to be performed by a user may be to remove a graphic object from the layout. This may be done by selecting a graphic object (502) from the layout. The cursor may then be moved to a predetermined location which indicates that the selected graphic object (502) is to be removed. One example of a predetermined location may be a delete box (504).

For example, a user may use click on object 3 (502) and drag the object 3 (502) to the delete box (504). The binary tree representing the layout may then be updated. The updated version of the binary tree may maintain all nodes within their respective locations in the tree except for the node representing object 3 (502). The node representing object 3 (502) may be removed from the tree structure. The layout as displayed to the user may then be updated in accordance with the removal. Other actions indicating the removal of a selected graphic object may also be used such as pressing the “delete” key.

FIG. 5B is a diagram showing an illustrative layout in which object 3 (502) has been removed. The remaining graphic objects (506) have been resized according to the object resizing image function. However, the remaining graphic objects (506) maintain their relative positions within the layout.

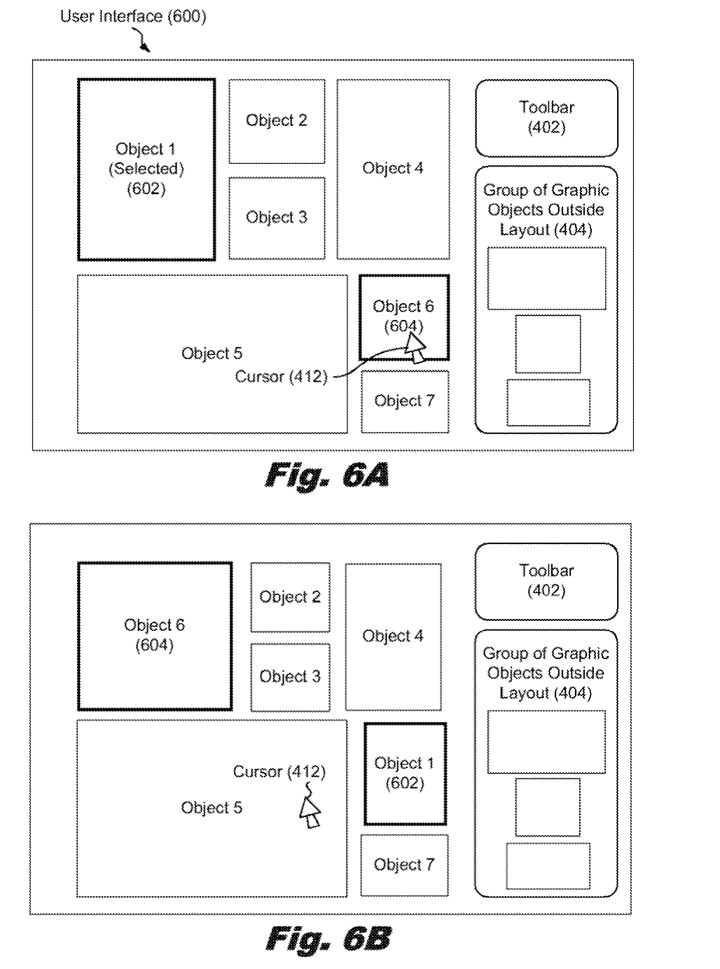

FIG. 6A is a diagram showing an illustrative user interface (600) before two graphic objects (602, 604) are swapped within the layout. According to certain illustrative embodiments, one of the editing actions able to be initiated by a user may be to swap two graphic objects (602, 604). This may be done by selecting a graphic object (602) from the layout and moving the cursor (412) to the center of another graphic object (604).

For example, a user may click on object 1 (602), the user may then drag the cursor (412) to a center sub-region associated with object 6 (604). The user may then release the mouse button indicating that object 1 (602) and object 6 (604) should be swapped. In some embodiments, object 6 (604) may be highlighted or become discolored to indicate that the cursor (412) is being held over the center sub-region associated with object 6 (604) as opposed to a side sub-region associated with object 6 (604). By performing this editing action, the binary tree structure representing the layout may be updated. The positions of object 1 (602) and object 6 (604) within the binary tree may be swapped.

FIG. 6B is a diagram showing an illustrative layout in which object 1 (602) and object 6 (604) have been swapped. The graphic objects not involved with the swap may maintain their relative positions. Additionally, both the graphic objects involved in the swap and the graphic objects not involved in the swap may be resized according to the new tree structure which has been created as a result of the swap.

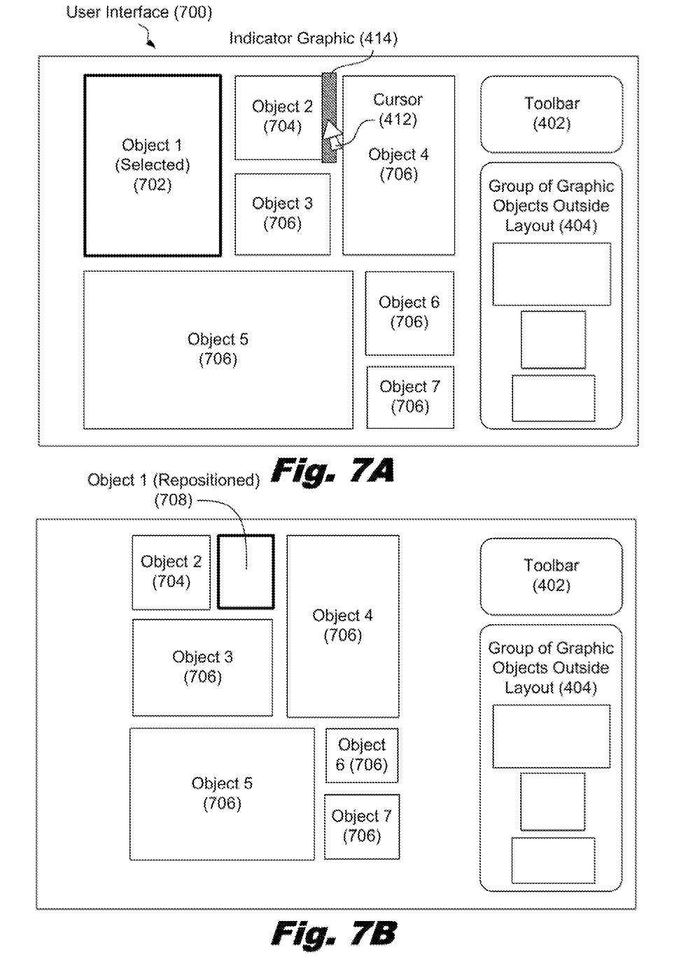

FIG. 7A is a diagram showing an illustrative user interface (700) before one of the graphic objects (702) is repositioned within the layout. According to certain illustrative embodiments, one of the editing actions able to be performed by a user is repositioning one of the graphic objects (702) within the layout. This may be done by first selecting one of the graphic objects to be repositioned. The selected graphic object (702) may then be dragged so that it is positioned above a sub-region associated with the border of another graphic object (704).

For example, a user may use a cursor to select graphic object 1 (702) by clicking on it. The user may then drag the cursor to a position corresponding to a sub-region associated with the right border of graphic object 2 (704). In some embodiments, the user may place the cursor on the inner side of an innermost nested rectangle associated with the screen map. An indicator graphic (414) may appear to inform the user that the cursor (412) is currently held within a sub-region associated with graphic object 2 (704). When the user releases the mouse button, the binary tree representing the layout may be updated. The nodes representing object 1 (702) and its parent may be removed from the tree. The interior node that is the parent of nodes 2 and 3 may be moved into the place formerly occupied by the parent of the node representing object 1 (702). The node representing object 2 (704) may then be displaced with a new vertical node indicating a vertical division. This new vertical node may have the nodes representing object 1 (702) and object 2 (704) as child nodes.

FIG. 7B is a diagram showing an illustrative layout in which object 1 (708) has been repositioned. The graphic objects (706) not involved with the reposition may maintain their respective positions. Additionally, all graphic objects within the layout may be resized according to their updated positions within the tree structure representing the layout. The resizing may be done according to constraints. For example, the resizing process may attempt to maintain the aspect ratio of each graphic object while only adjusting its area. In some cases, a minimal amount of cropping may be allowed.

In some embodiments, a user may select one of the rectangles associated with the screen map. For example, a user may wish to perform an editing action on a group of graphic objects. A user may select a particular region that includes more than one graphic object. For example, a user may select the region that encompasses graphic objects 1, 2, and 3 and perform an editing action. The vertical root node associated with graphic objects 1, 2, and 3 may be repositioned within the binary tree structure or removed from the binary tree structure based on the editing action performed.

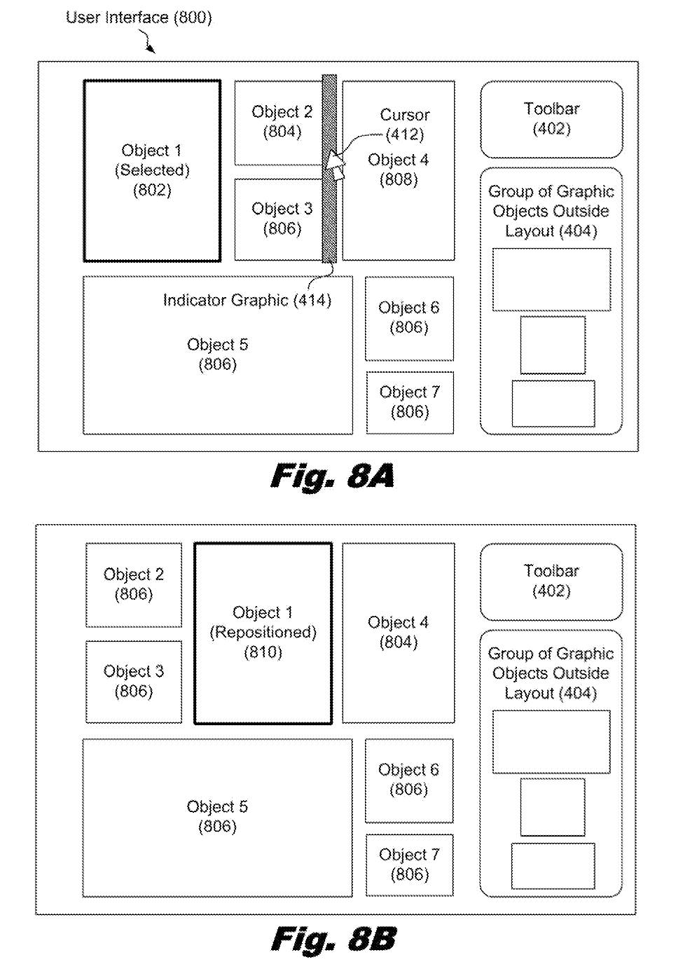

FIG. 8A is a diagram showing an illustrative user interface (800) before one of the graphic objects (802) is repositioned within the layout. As mentioned above, one of the editing actions able to be performed by a user is repositioning one of the graphic objects (802) within the layout. This may be done by first selecting one of the graphic objects (802) to be repositioned. The selected graphic object (802) may then be dragged so that it is positioned above a sub-region associated with a border of a bounding box encompassing graphic objects (804, 806).

In a similar case as illustrated above, a user may use a cursor to select graphic object 1 (802) by clicking on it. The user may then drag the cursor to a position corresponding to a sub-region associated with the region that is associated with the horizontal node whose child nodes represent objects 2 and 3 (804, 806). This region may be displayed to a user as a space outside the innermost nested rectangles around graphic objects 2 and 3 (804 and 806) and inside the nested rectangle that encloses only the original positions of objects 1 and 2 (804, 806). An indicator graphic (414) may appear to inform the user that the cursor (412) is currently held within the appropriate sub-region. When the user releases the mouse button, the binary tree representing the layout may be updated. The node representing object 1 (802) and its parent may be removed from the tree. The interior node that is the parent of nodes 2 and 3 may be moved into the place formerly occupied by the parent of the node representing object 1 (802). The node that is the parent of nodes 2 and 3 may then be displaced with a new vertical node indicating a vertical division. This new vertical node may have the parent of nodes 2 and 3 as one child node, and the repositioned node 1 as the other child node.

FIG. 8B is a diagram showing an illustrative layout in which object 1 (810) has been repositioned. The graphic objects (806) not involved with the reposition may maintain their respective positions. Additionally, all graphic objects within the layout may be resized according to their updated positions within the binary tree structure representing the layout.

Throughout the drawings, graphic objects are shown as straight rectangular objects with similar spacing between neighboring graphic objects. A system or method embodying principles described herein is not limited to such graphic objects. For example, a graphic object may be of a variety of shapes. Additionally, graphic objects may be titled or overlapped as preferred by a user. Furthermore, various types of border art and border techniques may be used for the various graphic objects associated with the layout.

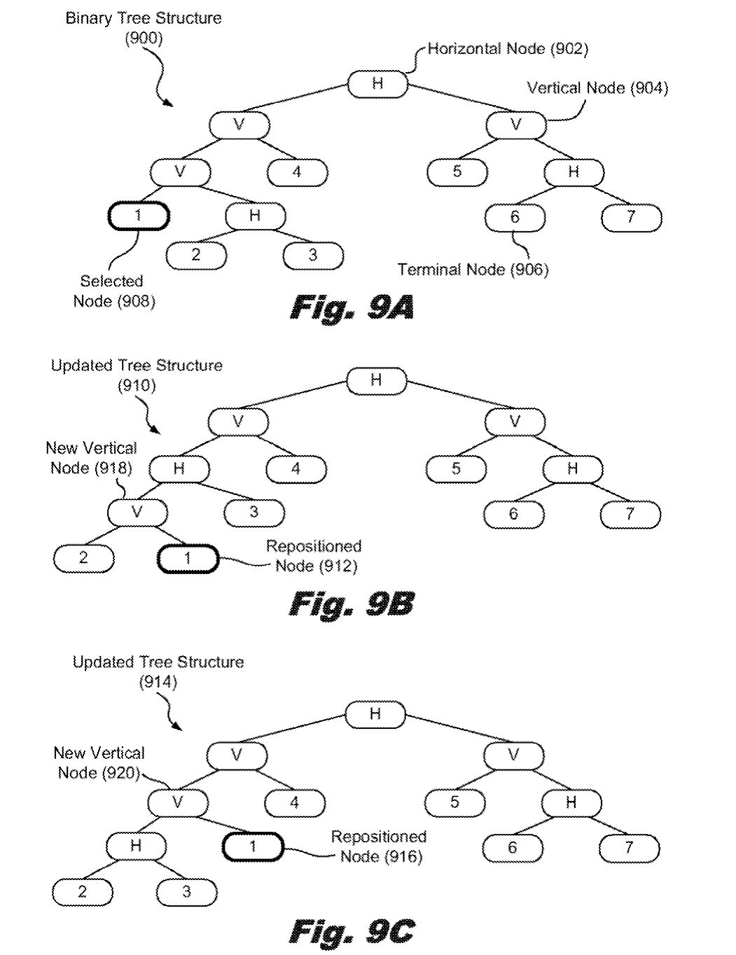

FIGS. 9A-9C are diagrams showing illustrative tree structures (900, 910, 914) representing layouts of graphic objects. As mentioned above, one data structure which may be used to represent a layout of graphic objects is a tree structure. FIG. 9A is a diagram of a binary tree structure (900) representing the original layout initially presented in FIG. 3A. FIG. 9B is a diagram of an illustrative updated tree structure (910) representing the restructured layout shown in FIG. 7B. Furthermore, FIG. 9C is a diagram showing an illustrative updated tree structure (914) representing the restructured layout shown in FIG. 8B.

As mentioned above, a tree structure may include horizontal nodes (902) representing horizontal divisions within the layout, vertical nodes (904) representing vertical divisions within the layout, and terminal nodes (906) representing the individual graphic objects in the layout. Throughout FIGS. 9A-9C, the letter “H” represents a horizontal node (902), the letter “V” represents a vertical node (904), and a number represents a specific graphic object as labeled in previous figures. For example, object one of FIG. 7B corresponds to the number 1 shown in FIGS. 9A-9C.

FIG. 9A illustrates a selected node (908) corresponding to the selected graphic object presented in both FIG. 7A and FIG. 8A. FIG. 7A illustrates the process of repositioning graphic object 1 to a position to the right of graphic object 2 and above object 3. After that reposition is indicated by a user, the binary tree structure may be updated as shown in FIG. 9B. The new vertical node (918) includes graphic objects 2 and 1 as its child nodes; graphic object 1 being associated with the repositioned node (912).

When object 1 is repositioned by a user to be adjacent to graphic objects 2 and 3 as shown in FIG. 8A, the binary tree structure may updated as shown in FIG. 9C. A new vertical node (920) includes the parent of graphic objects 2 and 3 as one of its child nodes, and the repositioned node (916) representing the repositioned graphic object 1 as the other of its child nodes.

The descriptions above relating to the updating of tree structures in response to editing actions performed by a user do not necessarily describe in detail every change that occurs within the tree structure according to the indicated editing action. The full change brought about to a tree structure in response to a particular editing action may be appreciated by one skilled in the relevant art.

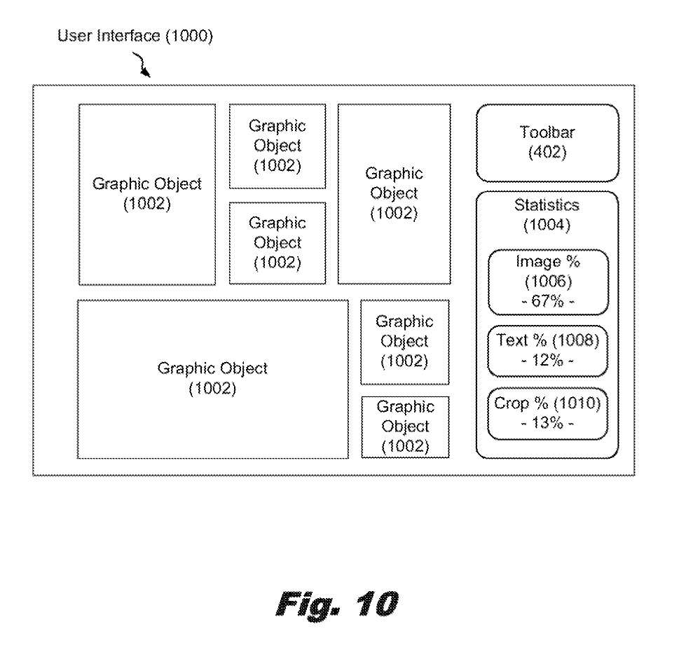

FIG. 10 is a diagram showing an illustrative user interface (1000) displaying statistics (1004) related to a graphic object layout. According to certain illustrative embodiments, a set of statistics (1004) including, but not limited to, percentage of area occupied by images (1006), percentage of area occupied by text (1008), and percentage of area being cropped away (1010) as a result of the current arrangement of graphic objects (1002).

As mentioned above, a graphic object may include text blocks as well as images. As a user incrementally creates and edits the layout of graphic objects (1002), the automatic graphic object resizing process may change the overall area delegated to each graphic object. The set of statistics (1004) may indicate to the user the current amount of area being used for images. Likewise, the set of statistics (1004) may show the current area delegated to text blocks. This statistic may be shown as an exact value or a percentage.

As mentioned above, the automatic graphic object resizing process may attempt to resize graphic objects (1002) with as little amount of cropping as necessary while still maintaining an aesthetically pleasing layout. The set of statistics (1004) may inform a user of the total area which has been cropped away from the current layout of graphic objects (1002). This statistic may be shown as an exact value or a percentage.

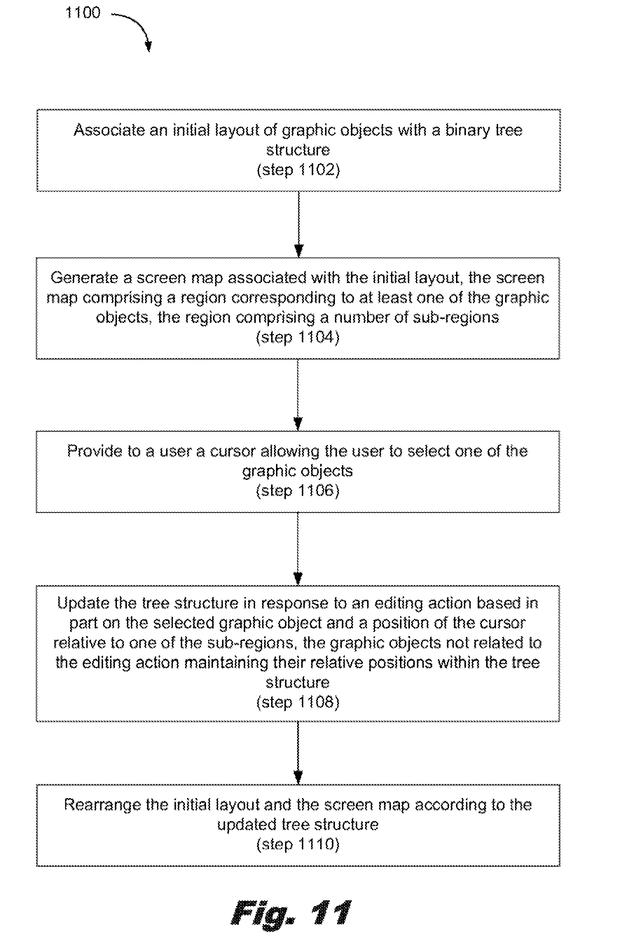

FIG. 11 is a flowchart showing an illustrative method for incremental graphic object editing. According to certain illustrative embodiments, the method may include associating (step 1102) an initial layout of graphic objects with a binary tree structure; generating (step 1104) a screen map associated with the initial layout, the screen map comprising a region corresponding to at least one of the graphic objects, the region comprising a number of sub-regions; providing (step 1106) to a user a cursor allowing the user to select one of the graphic objects; updating (step 1108) the tree structure in response to an editing action based in part on the selected graphic object and a position of the cursor relative to one of the sub-regions, the graphic objects not related to the editing action maintaining their relative positions within the tree structure; and rearranging (step 1110) the initial layout and the screen map according to the updated tree structure.

In sum, through use of a system or method embodying principles described herein, a user may intuitively perform editing actions incrementally without having the layout rearranged after each performed edit. Thus, a user may take advantage of systems which automatically rearrange and resize graphic objects and still move the layout towards a desired state.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for incremental graphic object (302) layout editing performed by physical computing system (100), the method comprising:
associating, with said physical computing system (100), an initial layout (300) of graphic objects (302) with a data structure;
generating, with said physical computing system (100), a screen map (304) associated with said initial layout (300), said screen map (304) comprising at least one region (306) associated with at least one of said graphic objects (302) from said initial layout (300), said region (306) comprising a number of sub-regions (308, 310) for each graphic object associated with said region (306);
providing to a user (112), with said physical computing system (100), a cursor (412) allowing said user (112) to indicate a selected region;
updating, with said physical computing system (100), said data structure in response to an editing action based in part on said selected region and a position of said cursor (412) relative to one of said sub-regions (308, 310), said graphic objects not related to said editing action maintaining their relative positions within said data structure; and
rearranging, with said physical computing system (100), said initial layout (300) and said screen map (304) according to said updated data structure.

2. The method of claim 1, further comprising, displaying to said user (112) an indicator graphic (414) showing which said sub-region (308, 310) said cursor (412) is currently within.

3. The method of any of claims 1-2, in which said data structure comprises a binary tree structure (900).

4. The method of any of claims 1-3, in which said editing action comprises adding an additional graphic object (410) to said layout if said selected region is associated with a graphic object (404) outside of said initial layout (304); in which a size of said additional graphic object (410) when placed in said initial layout is determined in part by a placed position of said additional graphic object (410) within said initial layout.

5. The method of any of claims 1-4, in which said editing action comprises removing said selected region and all graphic objects associated therewith if said selected region is said region (306) of said screen map (304) and after indicating said selected region, an action is performed indicating removal of said selected region.

6. The method any of claims 1-5, in which said editing action comprises repositioning said selected region if said selected region corresponds to said region (306) of said screen map (304) and after indicating said selected region, said position of said cursor (412) is moved by said user (112) to a side sub-region (308) of said screen map (304).

7. The method of claim 6, in which a size of said repositioned region is based in part on a new placement of said repositioned region within said initial layout (300).

8. The method of any of claims 1-7, further comprising tracking a number of statistics (1004) associated with said initial layout (300), said statistics (1004) including at least one of: a percentage (1008) of area in said initial layout occupied by text based graphic objects, a percentage (1006) of area in said initial layout occupied by image based graphic objects, and a cropped area (1010) of image based graphic objects.

9. A computing device for incremental graphic object (302) layout editing comprising:
a processor (104); and
a memory (102) communicatively coupled to said processor (104);
in which said processor (104) is configured to:
associate an initial layout (300) of graphic objects (302) with a data structure;
generate a screen map (304) associated with said initial layout (300), said screen map (304) comprising at least one region (306) associated with at least one of said graphic objects (302) from said initial layout (300), said region (306) comprising a number of sub-regions (308, 310) for each graphic object associated with said region (306);
provide to a user (112), a cursor (412) allowing said user (112) to indicate a selected region;
update said data structure in response to an editing action based in part on said selected region and a position of said cursor (412) relative to one of said sub-regions (308, 310), said graphic objects not related to said editing action maintaining their relative positions within said data structure; and
rearrange said initial layout (300) and said screen map (304) according to said updated data structure.

10. The device of claim 9, in which said data structure comprises a binary tree structure (900).

11. The device of any of claims 9-10, in which said editing action comprises adding an additional graphic object (410) if said selected region is associated with graphic objects (404) outside of said initial layout (300); in which a size of said additional graphic object (410) when placed in said layout is determined in part by a new placement of said selected graphic object within said layout.

12. The device of any of claims 9-11, in which said editing action comprises removing at least one of said graphic objects (302) if said selected region corresponds to said region (306) of said screen map (304) and after indicating said selected region, an action is performed indicating removal of s said selected region and all graphic objects associated therewith.

13. The device of any of claims 9-12, in which said editing action comprises repositioning said selected region if said selected region corresponds to said region (306) of said screen map (304) and after indicating said selected region, said position of said cursor (412) is moved to a side sub-region (308) of said screen map.
in which a size of said repositioned graphic object is determined by a length of a border associated with said side sub-region (308).

14. The device of any of claims 9-13, in which said processor (104) is further configured to track a number of statistics (1004) associated with said initial layout (300), said statistics (1004) including at least one of: percentage (1008) of area occupied by text based graphic objects, percentage (1006) of area occupied by image based graphic objects, and area (1010) of cropped away image based graphic objects.

15. A computer program product for incremental graphic object (302) layout (200) editing, said computer program product comprising:
a computer readable storage medium having computer readable code embodied therewith, said computer readable program code comprising:
computer readable program code configured to associate an initial layout (300) of graphic objects (302) with a data structure;
computer readable program code configured to generate a screen map (304) associated with said initial layout (300), said screen map (304) comprising at least one region (306) associated with at least one of said graphic objects (302) from said initial layout (300), said region (306) comprising a number of sub-regions (308, 310) for each graphic object associated with said region (306);
computer readable program code configured to provide to a user (112), a cursor (412) allowing said user (112) to indicate a selected region;
computer readable program code configured to update said data structure in response to an editing action based in part on said selected region and a position of said cursor (412) relative to one of said sub-regions (308, 310), said graphic objects not related to said editing action maintaining their relative positions within said data structure; and
computer readable program code configured to rearrange said initial layout (300) and said screen map (304) according to said updated data structure.
